(19) United States
(12) Patent Application Publication
(10) Pub. No.: US 2023/0198141 A1
(43) Pub. Date: Jun. 22, 2023

(54) ANTENNA DIRECTION WEIGHTINGS

(71) Applicant: HEWLETT-PACKARD DEVELOPMENT COMPANY, L.P., SPRING, TX (US)

(72) Inventors: CHIH-HUNG CHIEN, TAIPEI CITY (TW); CHIN-HUNG MA, TAIPEI CITY (TW); MIN-HSU CHUANG, TAIPEI CITY (TW)

(21) Appl. No.: 16/966,309

(22) PCT Filed: Apr. 13, 2018
(86) PCT No.: PCT/US2018/027589

§ 371 Date: Aug. 25, 2020

(51) Int. Cl. H01Q 3/04

(52) U.S. Cl. CPC H01Q 3/04

(57) ABSTRACT

An example antenna device includes an antenna array coupled to a motor. The antenna device also includes a controller to determine an antenna array direction weighting based on a weather condition and a time condition. The controller is also to cause the motor to rotate the antenna array based on the antenna array direction weighting.

### BACKGROUND

In wireless communication, antennas may send and receive wireless signals. Some antenna devices may use an array of antennas to enhance wireless communication. For example, an antenna device may include multiple antennas that are arranged in a grid. An antenna array may improve transmission and reception of wireless signals. For instance, an antenna array may perform beamforming that increases signal range while reducing the use of wireless resources.

### BRIEF DESCRIPTION OF THE DRAWINGS

FIG. 1 is a simplified isometric view of an example of an antenna device that may use an antenna array direction weighting;

FIG. 2 illustrates an example of antenna array rotation;

FIG. 3 is a block diagram of an example of an antenna device;

FIG. 4 illustrates an example of an antenna array direction weighting table;

FIG. 5 is a flow diagram illustrating an example of a method for antenna array direction weighting;

FIG. 6 is a flow diagram illustrating another example of a method for antenna array direction weighting;

FIG. 7 is a flow diagram illustrating yet another example of a method for antenna array direction weighting; and

FIG. 8 is a flow diagram illustrating another example of a method for antenna array direction weighting.

### DETAILED DESCRIPTION

In some wireless communication technologies, an antenna array may be used for transmission and reception of wireless signals. In an example, an antenna array may be used to increase signal-to-noise ratio (SNR) and signal transmitting range. In the 5th generation of mobile broadband technology (referred to as enhanced mobile broadband (eMBB)), communications between wireless devices may have a data-transfer rate up to 20 gigabit per second (Gbps).

To achieve data throughput of up to 20 Gbps, the transmission spectrum bandwidth (BW) may be in the gigahertz (GHz) range. This is much larger than previous 4G LTE technology, which normally occupies less than 100 megahertz (MHz) BW. However, the spectrum BW in lower frequency (e.g., less than 6 GHz) bands is limited and may not be able to provide such high BW. To achieve a high data rate, wireless communications may be implemented in millimeter-wavelength radio frequencies (mmWave).

Millimeter-wavelength electromagnetic waves may also be referred to as millimeter band, millimeter wave, MMW or mmW. In some examples, mmWave may operate in the 30 to 300 GHz frequency range. Millimeter waves may include microwaves and infrared waves. This spectrum may be used for high-speed and high-bandwidth wireless communications.

A wireless signal (e.g., radio frequency (RF) or microwave signal) transmitted in free space will degrade exponentially proportionate to its wavelength. Therefore, the loss in mmWave signals may be much higher than lower frequency (e.g., less than 6 GHz) signals. For example, a base station for current LTE applications may have a range of several kilometers. However the mmWave transmission range may be around 100 meters with the help beamforming technology.

For mmWave communication, antenna beamforming may combat the higher path loss due to a high operating frequency. With beamforming, a wireless signal may be directed through the use of multiple antennas in an antenna array. However, wireless communication with beamforming is not omni-directional and is limited to certain angle ranges. For example, some base stations using beamforming may have multiple antenna arrays to cover a range of directions. In some examples, three sets of antenna arrays arranged to form three sides of a triangle may be used to cover 360 degrees.

However, the cost of multiple antenna arrays may be significant. Additionally, the total power consumption may also be significant. For example, in the case of a 3 antenna array approach, costs and power consumption may be 3 times the costs and power consumption of a single antenna array approach.

This disclosure describes some examples of an antenna device that includes an antenna array. In some examples, the antenna device may be used for mmWave communications. Service coverage may be achieved by rotating the antenna array based on antenna array direction weightings determined from various conditions (e.g., environmental, season, time, etc.). By doing so, the cost of mmWave antennas may be lowered and the efficiency of the antenna transmission and reception may be increased.

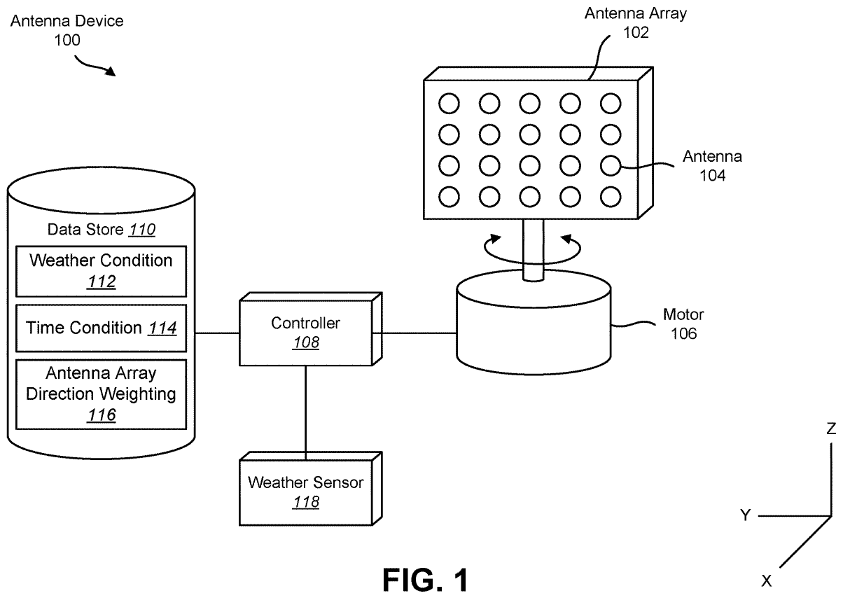

FIG. 1 is a simplified isometric view of an example of an antenna device 100 that may use an antenna array direction weighting 116. The antenna device 100 may include an antenna array 102 coupled to a motor 106. In FIG. 1, a single antenna array 102 is shown for purposes of illustration. In other examples, multiple antenna arrays 102 (e.g., 2) may be used.

In some examples, the antenna device 100 may be used for millimeter wave (mmWave) communication. For instance, the antenna device 100 may be included in a wireless communication base station. In other examples, the antenna device 100 may be included in a wireless router (e.g., WiFi router).

In an example for 5G mmWave, the number of base stations used in an area may be much higher than the number of current 4G/3G base stations due to the nature of mmWave wavelengths that have much higher air traveling loss. Furthermore, to have acceptable 5G coverage (e.g., around a few hundred meters) antenna beamforming may be used. In a dense area (e.g., an urban area), the antenna device 100 may be installed on a streetlight structure, a wall of a building, a traffic signal, etc.

In some examples, the antenna array 102 (also referred to as an array antenna or an array of antennas) may be a set of multiple antennas 104 that work together as a single antenna. The antenna array 102 may include multiple antennas 104 (which may also be referred to as “antenna elements” or “elements”). The antennas 104 may be connected to a single transceiver (i.e., transmitter and receiver) to transmit and receive electromagnetic signals (e.g., radio waves, microwaves, etc.). The transceiver may provide power to the individual antennas 104 in a specific phase relationship. In some examples, the antennas 104 may be mmWave antennas. For instance, the antennas 104 may perform 5G mmWave communications.

In some examples, the antenna array 102 may include multiple antennas 104 that are arranged in a grid pattern. In other examples, the antennas 104 of the antenna array 102 may be positioned in other (non-grid) configurations. For example, the antennas 104 may be arranged in a linear configuration.

The antenna array 102 may perform beamforming. Beams may be formed by shifting the phase of the signal emitted from each radiating antenna 104 to provide constructive interference and/or destructive interference so as to steer the beams in a desired direction. In some examples, the electromagnetic waves radiated or received by each individual antenna 104 may combine together (e.g., constructive interference) to enhance the power radiated or received in desired directions, and/or cancel (e.g., destructive interference) to reduce the power radiated or received in other directions. In some examples, the antenna array 102 may be a driven array with driven antennas 104 connected to the transceiver and fed in phase. In some examples, the antenna array 102 may be a phased antenna array that includes multiple radiating antennas 104, each with a phase shifter connected to the transceiver. In some examples, the antenna array 102 may be a parasitic array in which only one antenna 104 is connected to the transceiver and other antennas 104 are not.

With antenna beamforming, the service coverage of a single antenna array 102 may be limited to a given angle range in the direction that the antenna array 102 faces. For example, an antenna array 102 may provide service coverage up to 120 degrees that the antenna array 102 faces in the X-Y plane. Thus, the antenna array 102 may provide service coverage for a range of angles in the direction that the antenna array 102 faces. A single antenna array 102 may provide service coverage over an expanded range of angles in the X-Y plane by rotating the antenna array 102 on an axis (e.g., Z-axis) that is perpendicular to the X-Y plane. As the antenna array 102 rotates, the antenna array 102 may face different directions. Performance may be enhanced by rotating the antenna array 102 based on environmental conditions that are associated with antenna usage statistics.

The antenna device 100 may include a controller 108. The controller 108 may be a computing device, a semiconductor-based microprocessor, a central processing unit (CPU), a graphics processing unit (GPU), field-programmable gate array (FPGA), an application-specific integrated circuit (ASIC), a microcontroller unit (MCU), and/or other hardware device. The controller 108 may be connected to the antenna array 102 and the motor 106 via communication lines. The controller 108 may be connected to other components of the antenna device 100 via communication lines (not shown).

The controller 108 may communicate with a data store 110. The data store 110 may be a machine-readable storage medium. A machine-readable storage may be any electronic, magnetic, optical, or other physical storage device that stores executable instructions. Thus, a machine-readable storage medium may be, for example, Random-Access Memory (RAM), an Electrically Erasable Programmable Read-Only Memory (EEPROM), Magnetoresistive Random-Access Memory (MRAM), a storage drive, an optical disc, and the like.

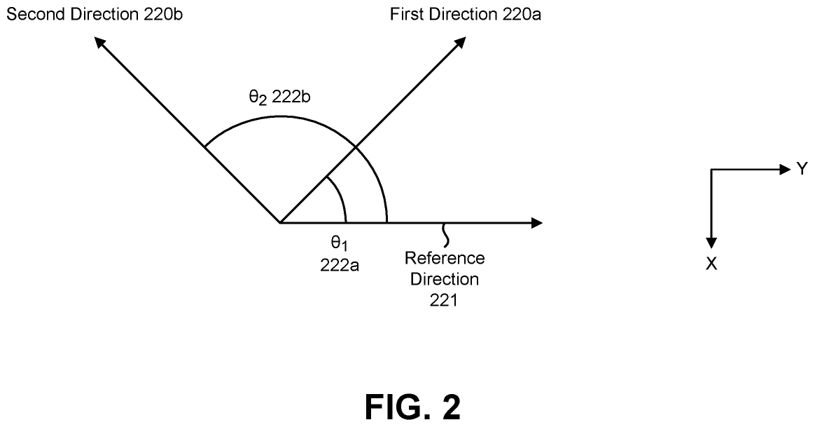

The data store 110 may include data pertaining controlling the antenna device 100. For example, the data store 110 may store data pertaining to rotating the antenna array 102 based on an antenna array direction weighting 116. As used herein, an antenna array direction weighting 116 may be amounts of time within a rotation cycle of the antenna array 102 that the antenna array 102 faces different directions. In other words, the antenna array direction weighting 116 may indicate amounts of time that the antenna array 102 faces different directions in a plane (e.g., X-Y plane). The antenna array 102 may be able to rotate about an axis (e.g., Z-axis) that is perpendicular to the plane to face different directions. In some examples, the antenna array directions in the antenna array direction weighting 116 may be expressed as an angle from a reference point as described in FIG. 2.

A rotation cycle may include a sequence (or pattern) of directions to which the antenna array 102 may rotate. The rotation cycle may repeat such that the antenna array 102 continually rotates according to the direction sequence. In some examples, the antenna array 102 may rotate in a single direction (e.g., clockwise or counter-clockwise). For instance, the antenna array 102 may rotate clockwise to a number of directions in a 360-degree range, whereupon the antenna array 102 may continue rotating in the same direction according to the direction sequence.

In some examples, the antenna array 102 may rotate back and forth through a range of angles in a oscillating manner. For instance, the antenna array 102 may rotate clockwise to a number of directions over a 180-degree range. The antenna array 102 may then rotate counter-clockwise to a number of directions over the 180-degree range.

In some examples, a given direction in the antenna array direction weighting 116 may be weighted differently than other directions. In other words, the antenna array direction weighting 116 may indicate that the antenna array 102 faces a given direction for a different amount of time than other directions. The antenna array direction weighting 116 may emphasize one or more directions over other directions. For example, a first direction may be weighted more than a second direction in the antenna array direction weighting 116. In this case, the antenna array 102 may face the first direction longer than the second direction in a rotation cycle.

In some examples, the antenna array direction weighting 116 may include time percentages for directions that the antenna array 102 faces within a rotation cycle. In one example, the amount of time for the antenna array 102 to complete a rotation cycle (e.g., to rotate through a range of angles) may be time T. The antenna array direction weighting 116 may include a first percentage (A %) that the antenna array 102 is to face a first direction and a second percentage (B %) that the antenna array 102 is to face a second direction, and so forth. Therefore, the time in one rotation cycle that the antenna array 102 faces the first direction may be defined as T*A %, and the time in one rotation cycle that the antenna array 102 faces the second direction may be defined as T*B %. It should be noted that in this example, two directions were described. However, the antenna array direction weighting 116 may include any number of directions for the antenna array 102.

In some examples, the antenna array direction weighting 116 may be expressed in discrete time units (e.g., seconds, milliseconds, etc.) per rotation cycle. In one example, the antenna array direction weighting 116 may include a first direction time (T_{A}) that the antenna array 102 faces a first direction and a second direction time (T_{B}) that the antenna array 102 faces a second direction. The summation of T_{A} and T_{B} may equal the total rotation cycle time T (i.e., T_{A}+T_{B}=T). In this case, T_{A} may or may not equal T_{B}.

In an example, the directions for the antenna array 102 that are included in the antenna array direction weighting 116 may be defined by angles from a reference point. An example depicting rotation of the antenna array 102 to two directions is described in FIG. 2.

As described below, the machine-readable storage medium may also be encoded with executable instructions for controlling the antenna device 100. For example, the data store 110 may include machine-readable instructions that cause the controller 108 to determine an antenna array direction weighting 116 based on a weather condition 112, a time condition 114 and/or camera scan.

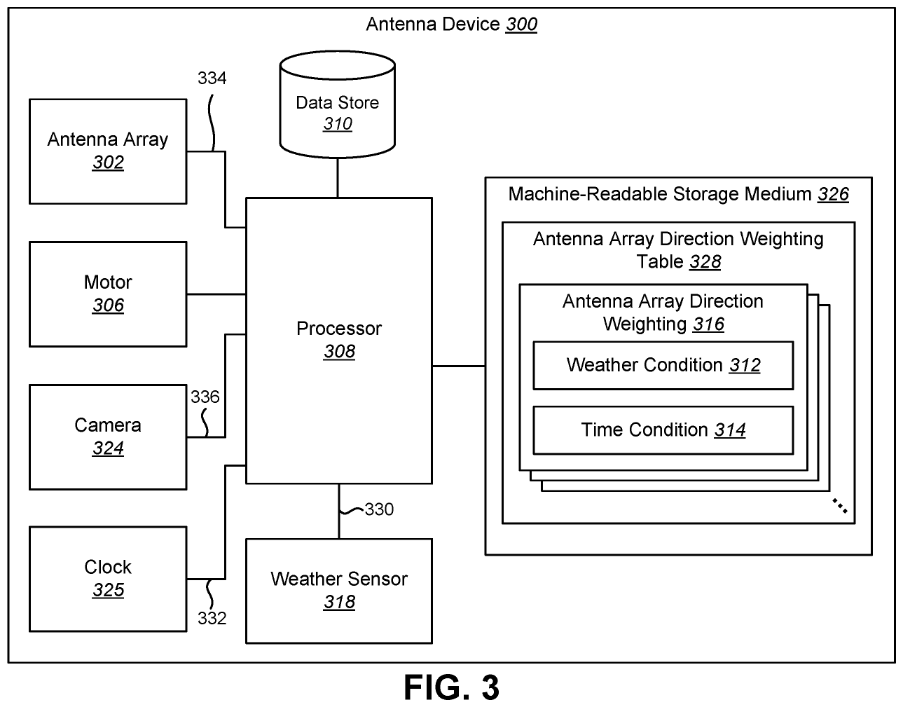

In an example, the machine-readable instructions may cause the controller 108 to determine the antenna array direction weighting 116 based on a weather condition 112, a time condition 114 and/or camera scan results. A given antenna array direction weighting 116 may be associated with a certain weather condition 112, time condition 114 and/or camera scan. In some examples, the data store 110 may include multiple antenna array direction weighting 116 in an antenna array direction weighting table. Examples of the antenna array direction weighting table are described in connection with FIG. 3.

The antenna array direction weighting 116 may be associated with a weather condition 112, a time condition 114 and/or camera scan. In an example, the weather condition 112 associated with the antenna array direction weighting 116 may include conditions about temperature, humidity (e.g., rain, snow, ice, dry, etc.), cloud-cover, barometric pressure, and/or wind. The weather condition 112 may include a threshold or range of conditions that would be included in the weather condition 112. For example, temperatures within a 10 degree Fahrenheit range may meet a weather condition 112 of a given antenna array direction weighting 116.

In another example, the time condition 114 associated with the antenna array direction weighting 116 may include conditions associated with date and/or time. Examples of the time condition 114 may include a specific date, season (e.g., spring, summer, autumn, winter), time-of-day (e.g., hour; daytime, nighttime, lunchtime, dinnertime, morning, afternoon, etc.), day-of-week (e.g., weekday or weekend), holidays (e.g., national holidays, regional holidays, religious holidays), and/or regional events (e.g., festivals, conventions, sporting events, etc.). The time condition 114 may include a threshold or range of conditions that would be included in the time condition 114. For example, a range of hours may meet the time condition 114 of a given antenna array direction weighting 116.

In some examples, the machine-readable instructions may cause the controller 108 to determine current weather information and time information. For instance, the controller 108 may receive weather information from a weather sensor 118 that is coupled to the antenna device 100. The weather sensor 118 may collect weather information at the antenna device 100. The weather information may include measurements of temperature, humidity (e.g., rain, snow, ice, dry, etc.), cloud-cover, barometric pressure, and/or wind. The controller 108 may obtain the time information from a clock (e.g., an on-board clock or network clock signal).

The controller 108 may compare the weather information and time information to the weather condition 112 and time condition 114 associated with the antenna array direction weighting 116. When current weather conditions and time conditions match the stored weather condition 112 and time condition 114 associated with the antenna array direction weighting 116, then the controller 108 may select the antenna array direction weighting 116 for the antenna array rotation.

In some examples, the machine-readable instructions may cause the controller 108 to perform a camera scan. For example, the controller 108 may receive camera information (e.g., digital images and/or a video stream) captured by one or more cameras. The controller 108 may determine conditions from the camera information that may be used to select an antenna array direction weighting 116. For example, a camera field-of-view may be mapped to a direction of the antenna array 102. The controller 108 may detect human traffic in one or more regions observed by the camera.

Using the orientation of the camera and the mapped antenna array directions, the controller 108 may determine an antenna array direction weighting 116 based on the detected human traffic. For example, if a first direction of the antenna array 102 has more human traffic than a second direction, the antenna array direction weighting 116 may have the antenna array 102 face the first direction longer than the second direction.

In some examples, the antenna array direction weighting table may include different antenna array direction weightings 116 for different weather conditions 112 and different time conditions 114. Furthermore, in some examples, the antenna array direction weighting table may include different antenna array direction weightings 116 for different camera scans (e.g., directions corresponding to detected human traffic). For example, antenna usage may vary at a first direction and a second direction based on various weather conditions 112, time conditions 114 and/or camera scans.

In an example, the antenna device 100 may be located on a streetlight. When the antenna array 102 faces a first direction, the antenna array 102 may service a coffee shop. When the antenna array 102 faces a second direction, the antenna array 102 may service a sidewalk. In an example, in cold weather, it is likely that most users with mobile devices communicating with the antenna device 100 would stay inside the coffee shop. In this case, the weighting of the first direction toward the coffee shop may be high and the second direction toward the sidewalk may be low. Similarly, on a rainy day, most of the users would stay inside the coffee shop, and the weighting of the first direction toward the coffee shop may be high and the second direction toward the sidewalk may be low. In good weather (e.g., sunny and warm), the distribution of users inside the coffee shop and on the sidewalk may be even. In this case, the weighting of the first direction (e.g., the coffee shop) and the second direction (e.g., the sidewalk) may be even (e.g., 50% toward the first direction and 50% toward the sidewalk).

In some examples, the antenna array direction weighting 116 may be selected based on time-of-day. For example, in daytime the user distribution may be even and the weighting of the first direction (e.g., the coffee shop) and the second direction (e.g., the sidewalk) may be even (e.g., 50% toward the first direction and 50% toward the sidewalk). In another example, in nighttime the user distribution may be mostly inside the coffee shop and the weighting of the first direction toward the coffee shop may be high and the second direction toward the sidewalk may be low.

In some examples, the antenna array direction weighting 116 may be selected based on day-of-week (e.g., weekday or weekend). In an example, on weekdays, most users may enter the coffee shop and take away the coffee, whereas on weekends the users may stay inside and outside the coffee shop evenly. Therefore, the antenna array direction weighting 116 may reflect these usage patterns based on the current day-of-week.

In some examples, the machine-readable instructions may cause the controller 108 to cause the motor 106 to rotate the antenna array 102 based on the antenna array direction weighting 116. As described above, the antenna array direction weighting 116 may indicate amounts of time (e.g., percentages) that the antenna array 102 faces different directions. The controller 108 may instruct the motor 106 to rotate the antenna array 102 as indicated by the antenna array direction weighting 116. For example, the controller 108 may cause the motor 106 to rotate the antenna array 102 to a first direction for T*A % of a rotation cycle. The controller 108 may then cause the motor 106 to rotate the antenna array 102 to a second direction for T*B % of the rotation cycle.

In some examples, the motor 106 may rotate the antenna array 102 to a first direction and then stop the rotation for a time as indicated by the antenna array direction weighting 116. The motor 106 may then rotate the antenna array 102 to a second direction and then stop the rotation for a time as indicated by the antenna array direction weighting 116, and so forth.

In some examples, the motor 106 may rotate the antenna array 102 through different directions by varying the rate of rotation based on the antenna array direction weighting 116. For example, the antenna array direction weighting 116 may indicate that a first direction has a higher weighting than a second direction. In this case, the controller 108 may cause the motor 106 to rotate the antenna array 102 through a range of angles associated with the first direction more slowly than a range of angles associated with the second direction. Thus, in a rotation cycle, the antenna array 102 may spend more time facing the first direction as compared to the second direction.

In some examples, the controller 108 may occasionally cause the motor 106 to rotate the antenna array 102 to all service directions to service all possible clients. For example, the controller 108 may occasionally disregard the antenna array direction weighting 116 and may cause the motor 106 to rotate the antenna array 102 evenly through a range of angles. In this manner, the antenna device 100 may provide service to clients that are in locations that may be missed by antenna array direction weighting 116.

The antenna device 100 may include additional components (not shown). Further, some of the components described herein may be removed and/or modified without departing from the scope of this disclosure. The antenna device 100 as depicted in FIG. 1 may not be drawn to scale and may have a different size and/or configuration than shown. For instance, the antenna device 100 may include one or more cameras to capture image data. In another example, the antenna device 100 may include any number of antenna arrays 102. For example, the antenna device 100 may include two antenna arrays 102 that are oriented in different directions.

In addition, one or more components disclosed herein may be external to the antenna device 100. For instance, the controller 108 may be located remotely from the antenna array 102 and/or motor 106.

FIG. 2 illustrates an example of antenna array rotation. In this example, the antenna array 102 may rotate through a range of angles 222 in an X-Y plane. A reference direction 221 may be an orientation of the antenna array 102 with an angle 222 of zero. In a first direction 220a, the orientation of the antenna array 102 may have an angle (θ₁) 222a from the reference direction 221. In other words, the antenna array 102 may rotate from the reference direction 221 through angle (θ₁) 222a to face the first direction 220a. In a second direction 220b, the antenna array 102 may have an angle (θ₂) 222b from the reference direction 221.

In some examples, the antenna array direction weighting 116 described in FIG. 1 may include weightings for different directions 220 of the antenna array 102. For example, the antenna array direction weighting 116 may include a weighting for the first direction 220a and a weighting for the second direction 220b.

FIG. 3 is a block diagram of an example of an antenna device 300. In an example, the antenna device 300 may be equivalent to the antenna device 100 depicted in FIG. 1.

The antenna device 300 may include an antenna array 302, a motor 306, a processor 308, a data store 310, a camera 324, a weather sensor 318, a clock 325, and a machine-readable storage medium 326. The antenna device 300 may further include additional components (not shown) and some of the components described herein may be removed and/or modified without departing from the scope of this disclosure.

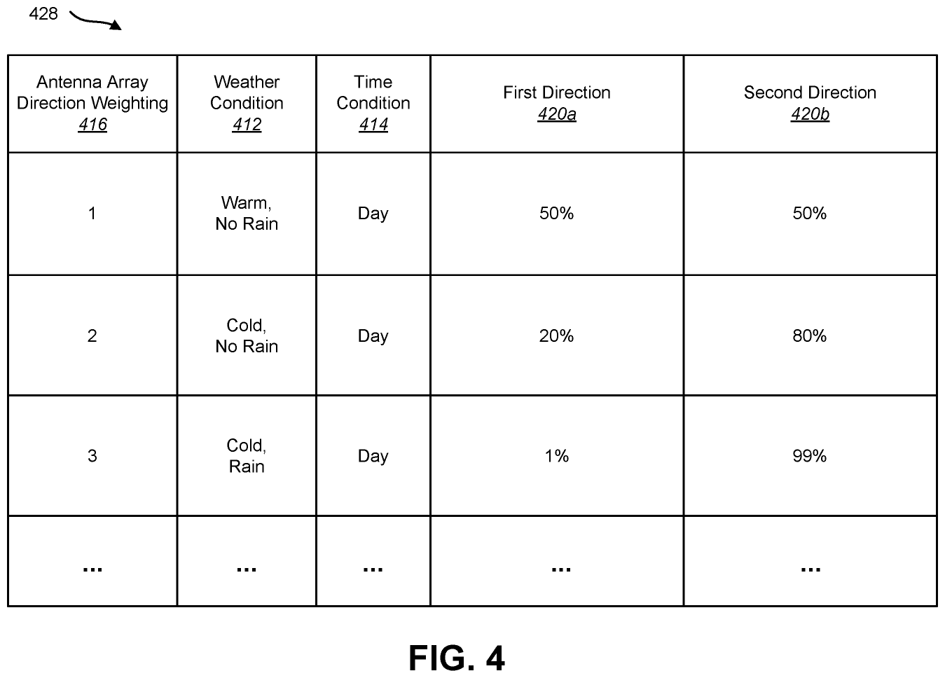

In an example, the processor 308 may be equivalent to the controller 108 depicted in FIG. 1. The processor 308 may be any of a central processing unit (CPU), a microcontroller unit (MCU), a semiconductor-based microprocessor, GPU, FPGA, an application-specific integrated circuit (ASIC), and/or other hardware devices suitable for retrieval and execution of instructions stored in the machine-readable storage medium 326. The processor 308 may fetch, decode, and execute instructions, stored on the machine-readable storage medium 326, to control the rotation of the antenna array 302 based on an antenna array direction weighting 316. As an alternative or in addition to retrieving and executing instructions, the processor 308 may include an electronic circuit and/or electronic circuits that include electronic components for processes related to rotation of the antenna array 302 based on an antenna array direction weighting 316. These processes are further described in detail below with respect to FIGS. 4-8.

The machine-readable storage medium 326 may be any electronic, magnetic, optical, or other physical storage device that contains or stores executable instructions. Thus, the machine-readable storage medium 326 may be, for example, RAM, EEPROM, a storage device, an optical disc, and the like. In some examples, the machine-readable storage medium 326 may be a non-transitory machine-readable storage medium, where the term “non-transitory” does not encompass transitory propagating signals.

The antenna device 300 may also include a data store 310 on which the processor 308 may store information, such as information pertaining to weather information and/or time information. The data store 310 may be volatile and/or non-volatile memory, such as DRAM, EEPROM, MRAM, phase change RAM (PCRAM), memristor, flash memory, and the like.

In an example, the machine-readable storage medium 326 may include an antenna array direction weighting table 328. The processor 308 may create the antenna array direction weighting table 328 for different weather conditions 312 and different time conditions 314. The antenna array direction weighting table 328 may include different antenna array direction weightings 316 for the different weather conditions 312 and the different time conditions 314.

The processor 308 may create the antenna array direction weighting table 328 based on antenna usage information 334 associated with the different weather conditions 312 and the different time conditions 314. The antenna usage information 334 may include the number of client devices in communication with the antenna device 300 at a given direction of the antenna array 302. For example, in a first direction the antenna array 302 may communicate with a first number of client devices, while in a second direction the antenna array 302 may communicate with a second number of client devices.

In an example, the antenna device 300 may be included in a base station. In this case, a base station control unit may have information about the user equipments (UEs) that are connected to it. It should be noted that due to beamforming technology, the antenna array 302 may tune the beam direction. Therefore, for a given angle (i.e., direction) of the antenna array 302, the antenna array 302 may cover substantially the whole plane in front of it. In some examples, the antenna array 302 may communicate with all the UEs by time scheduling. Therefore, if all the UEs are in the front plane of that antenna array 302, then the base station may communicate with those UEs.

In an example, the processor 308 may determine antenna usage information 334 while the antenna array 302 rotates through a range of directions. For example, the processor 308 may cause the motor 306 to rotate the antenna array 302 through a complete rotation cycle (e.g., 360 degrees). The processor 308 may determine the antenna array usage at different directions of the antenna array 302.

The processor 308 may also measure the current weather condition and current time condition. For example, the processor 308 may obtain weather information 330 from a weather sensor 318. The weather information 330 may include temperature information, humidity information, and/or wind information. The processor 308 may obtain time information 332 from a clock 325.

The processor 308 may create an antenna array direction weighting 316 for the current weather condition 312 and the current time condition 314 based on the associated antenna usage information 334. For example, antenna array directions that have higher antenna usage may have a higher weighting than antenna array directions that have lower antenna usage.

In an example, creation of an antenna array direction weighting 316 may begin by rotating the antenna array 302 evenly. In some examples, the motor 306 may rotate the antenna array 302 to different directions that are evenly spaced. For instance, the processor 308 may cause the motor 306 to step through 120 degrees within a 360 degree rotation. This may be because the antenna array 302 can cover users within a 120 degree range. The user amounts (e.g., the number of client devices in communication with the antenna array 302) per angle step may be measured. From these measurements, the user percentage for each angle step may be calculated. Over time, the probability of users per antenna array direction for similar conditions (e.g., weather, time, and/or camera scans . . . ) may be averaged and stored in an antenna array direction weighting 316.

To create the antenna array direction weighting 316, the processor 308 may also analyze the weather information 330 and time information 332 to determine the weather condition 312 and time condition 314 associated with the antenna array direction weighting 316. For example, a range of the measured temperature, humidity, and/or wind may be associated with the created antenna array direction weighting 316. Similarly, the processor 308 may generate a time condition 314 (e.g., day, night, weekend, weekday, etc.) for the created antenna array direction weighting 316 based on the current time information 332 obtained from the clock 325.

In an example, the processor 308 may group conditions. For example, a similar group of conditions (e.g., same weather, same season, same weekday) may be associated with a given probability of users per antenna array direction. The processor 308 may generate a list of the condition groups on the basis of their probability.

The created antenna array direction weighting 316 may be saved in an antenna array direction weighting table 328. An example of an antenna array direction weighting table 328 is described in FIG. 4.

In some examples, the processor 308 may select an antenna array direction weighting 316 from the antenna array direction weighting table 328 based on the weather condition 312 and the time condition 314. For example, the processor 308 may periodically (e.g., on-the-minute, hourly, daily, weekly, etc.) check current weather and time conditions against the weather conditions 312 and time conditions 314 saved in the antenna array direction weighting table 328. If the current weather and time conditions match weather conditions 312 and time conditions 314 of an antenna array direction weighting 316, then the processor 308 may use that antenna array direction weighting 316 to cause the motor 306 to rotate the antenna array 302.

In some examples, the processor 308 may also determine the antenna array direction weighting 316 based further on camera information 336. For example, the processor 308 may obtain camera information 336 from a camera 324. The camera information 336 may include digital images or a video stream. The processor 308 may analyze the camera information 336 when creating an antenna array direction weighting 316. For example, the processor 308 may use object detection to detect and count people in an image or video stream. The processor 308 may cause the motor 306 to rotate the antenna array 302 based on the detected human traffic. For instance, it may be more likely that antenna usage will be higher in areas with high human traffic. Antenna array directions corresponding to high human traffic may be given higher weighting in the antenna array direction weighting 316.

The antenna device 300 may be a self-improving system that adapts its antenna array coverage in response to changing environmental conditions. This provides an economic way for less dense 5G usage area. Costs may be reduced through the use of a rotating antenna array 302 while providing complete service coverage. For example, all directions may be covered with different weighting due to real usage cases. Furthermore, adjustments to the antenna array coverage may be made through self-learning that accounts for changing environmental conditions present at the antenna device 300. These adjustments may be made through data analysis of weather information 330, time information 332 and/or camera information 336 obtained at the antenna device 300.

The described antenna device 300 may reduce costs by using a single antenna array 302 instead of multiple (e.g., 3) antenna arrays. The described antenna device 300 may also reduce overall power consumption by using a single antenna array 102. Furthermore, the described antenna device 300 may also provide better resource sharing as compared to omni-directional antennas. Instead, the described antenna device 300 directs wireless signals and avoids wasting the wireless spectrum.

FIG. 4 illustrates an example of an antenna array direction weighting table 428. In some examples, the antenna array direction weighting table 428 may be created by an antenna device 300 as described in FIG. 3.

The antenna array direction weighting table 428 may include a number of antenna array direction weightings 416. Each antenna array direction weighting 416 may have a weather condition 412 and time condition 414 and corresponding direction weightings for a first direction 420a and a second direction 420b.

An example of a first antenna array direction weighting 416 has a time condition 414 of “day” and weather conditions 412 of “Warm, No Rain.” For these conditions 412, 414, the first direction 420a has a weighting of 50% and the second direction 420b has a weighting of 50%. In other words, the antenna array 302 should face the first direction 420a 50% of the time and the second direction 420b 50% of the time.

An example of a second antenna array direction weighting 416 has a time condition 414 of “day” and weather conditions 412 of “Cold, No Rain.” For these conditions 412, 414, the first direction 420a has a weighting of 20% and the second direction 420b has a weighting of 80%. In other words, the antenna array 302 should face the first direction 420a 20% of the time and the second direction 420b 80% of the time.

An example of a third antenna array direction weighting 416 has a time condition 414 of “day” and weather conditions 412 of “Cold, Rain.” For these conditions 412, 414, the first direction 420a has a weighting of 1% and the second direction 420b has a weighting of 99%. In other words, the antenna array 302 should face the first direction 420a 1% of the time and the second direction 420b 99% of the time.

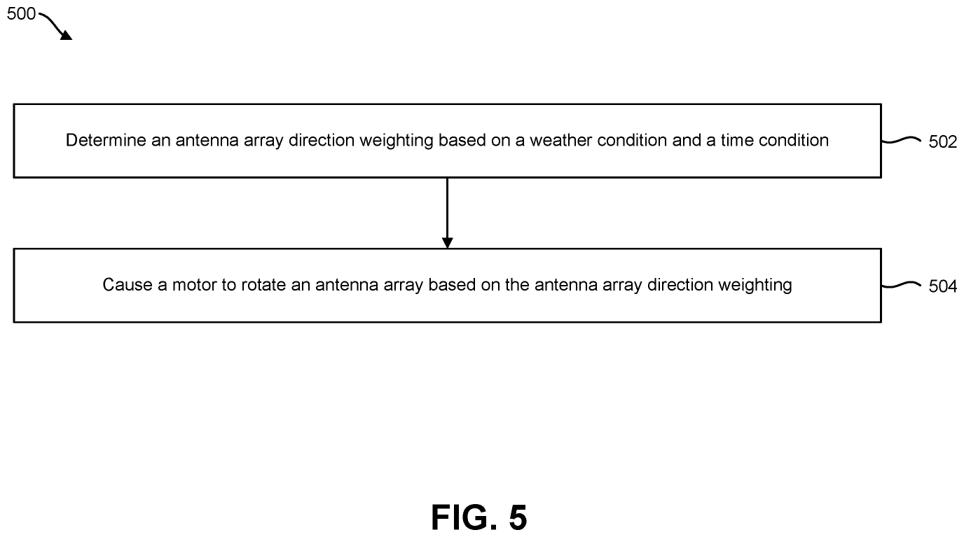

FIG. 5 is a flow diagram illustrating an example of a method 500 for antenna array direction weighting. The method 500 for antenna array direction weighting may be performed by, for example, the controller 108 described in FIG. 1 (and/or by the processor 308 described in FIG. 3).

The controller 108 may determine 502 an antenna array direction weighting 116 based on a weather condition 112 and a time condition 114. For example, the apparatus may obtain current weather information and time information. The controller 108 may obtain the weather information from a weather sensor 118 coupled to the antenna device 100.

The controller 108 may determine if the current weather information and time information matches a weather condition 112 and a time condition 114 associated with the antenna array direction weighting 116. The antenna array direction weighting 116 may indicate amounts of time that the antenna array 102 faces different directions. For example, the antenna array direction weighting 116 may include time percentages for directions that the antenna array 102 faces within a rotation cycle.

The controller 108 may cause 504 the motor 106 to rotate the antenna array 102 based on the antenna array direction weighting 116. For example, the controller 108 may instruct the motor 106 to rotate the antenna array 102 to the directions indicated by the antenna array direction weighting 116. The controller 108 may instruct the motor 106 to keep the antenna array 102 at a given direction for the amount of time indicated by the antenna array direction weighting 116.

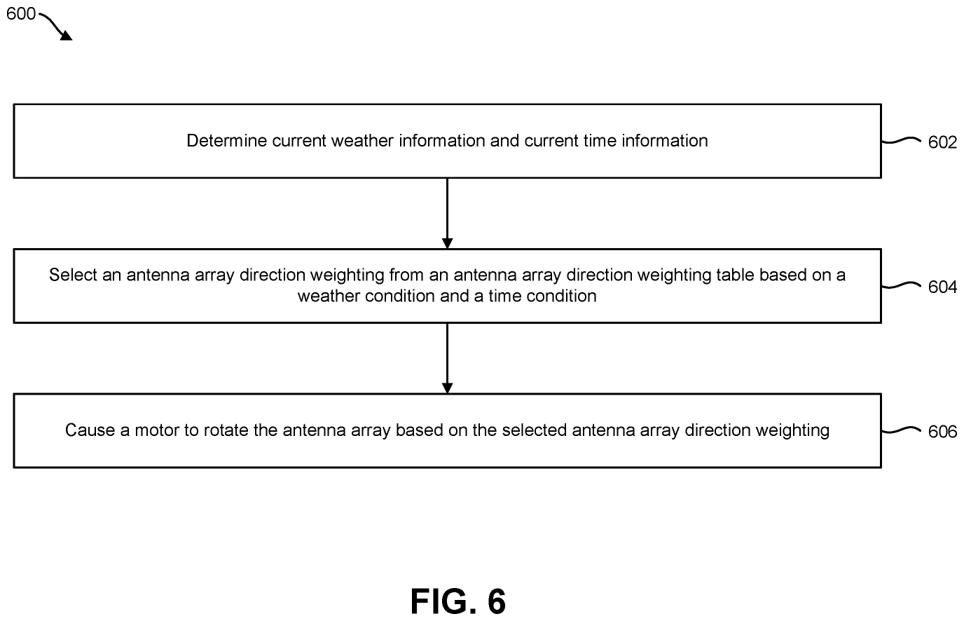

FIG. 6 is a flow diagram illustrating another example of a method 600 for antenna array direction weighting. The method 600 for antenna array direction weighting may be performed by, for example, the controller 108 described in FIG. 1 (and/or by the processor 308 described in FIG. 3).

The controller 108 may determine 602 current weather information and current time information. For instance, the controller 108 may receive weather information from a weather sensor 118 that is coupled to the antenna device 100. The weather sensor 118 may collect weather information at the antenna device 100. The weather information may include measurements of temperature, humidity (e.g., rain, snow, ice, dry, etc.), cloud-cover, barometric pressure, and/or wind. The controller 108 may obtain the time information from a clock (e.g., an on-board clock or network clock signal).

The controller 108 may select 604 an antenna array direction weighting 316 from an antenna array direction weighting table 328 based on a weather condition 312 and a time condition 314. The antenna array direction weighting table 328 may include different antenna array direction weightings 316 for the different weather conditions 312 and the different time conditions 314. The controller 108 may compare the current weather information and the current time information against the weather conditions 312 and time conditions 314 saved in the antenna array direction weighting table 328. If the current weather and time information match weather conditions 312 and time conditions 314 of an antenna array direction weighting 316, then the controller 108 may select that antenna array direction weighting 316. In other words, the controller 108 may select 604 an antenna array direction weighting 316 in the antenna array direction weighting table 328 with a weather condition 312 and a time condition 314 that matches the current weather information and current time information.

The controller 108 may cause 606 a motor 106 to rotate the antenna array 102 based on the selected antenna array direction weighting 316. For example, the controller 108 may instruct the motor 106 to rotate the antenna array 102 to the directions for the times indicated by the antenna array direction weighting 316.

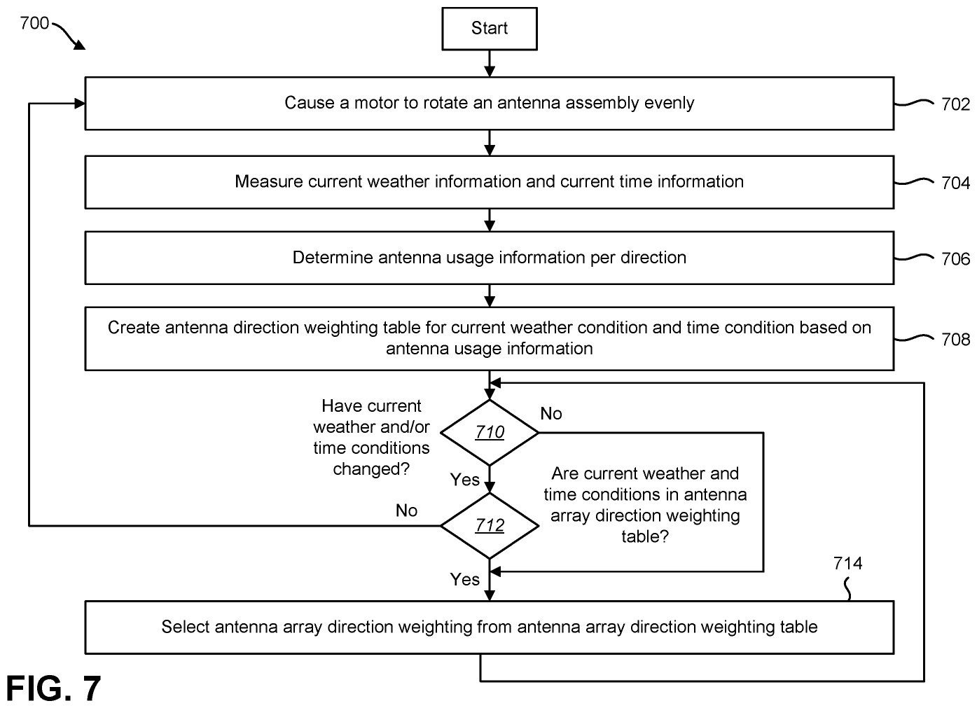

FIG. 7 is a flow diagram illustrating yet another example of a method 700 for antenna array direction weighting. The method 700 for antenna array direction weighting may be performed by, for example, the controller 108 described in FIG. 1 (and/or by the processor 308 described in FIG. 3).

The controller 108 may cause 702 a motor 106 to rotate an antenna array 102 evenly. For example, the controller 108 may instruct the motor 106 to rotate the antenna array 102 with a fixed angle velocity through a range of angles (e.g., 360 degrees). In another example, the controller 108 may instruct the motor 106 to rotate the antenna array 102 to multiple directions with a fixed weighting.

The controller 108 may measure 704 current weather information and current time information. For instance, the controller 108 may receive weather information from a weather sensor 118 that is coupled to the antenna device 100. The weather sensor 118 may collect weather information at the antenna device 100. The weather information may include measurements of temperature, humidity (e.g., rain, snow, ice, dry, etc.), cloud-cover, barometric pressure, and/or wind. The controller 108 may obtain the time information from a clock (e.g., an on-board clock or network clock signal).

The controller 108 may determine 706 antenna usage information 334 per direction. For example, while the antenna array 102 rotates through a range of angles, the controller 108 may measure the number of client devices in communication with the antenna device 100 for different directions of the antenna array 102. In the context of 5G mmWave, the controller 108 may determine the 5G usage rate per direction.

In some examples, the controller 108 may obtain camera information 336 from a camera 324. The controller 108 may monitor human traffic as observed in the camera information 336.

The controller 108 may analyze the collected data to create 708 an antenna array direction weighting table 328. For example, the controller 108 may assign directions with high antenna usage (and/or observed human traffic) a higher weighting (e.g., time percentage) in an antenna array direction weighting 316 than directions with low antenna usage (and/or observed human traffic). The controller 108 may also determine weather conditions 112 and time conditions 114 associated with the antenna array direction weighting 316 based on the current weather information and time information. The controller 108 may save the antenna array direction weighting 316 and associated weather conditions 112 and time conditions 114 in the antenna array direction weighting table 328. Thus, the antenna array direction weighting table 328 may include multiple antenna array direction weightings 316 for directional usage rates under different environmental conditions.

The controller 108 may determine 710 if current weather and/or time conditions have changed. For example, the controller 108 may analyze current weather information and time information to determine if previous weather and time conditions exist. In an example, a previous weather condition 112 may have been “Cold and Rain.” The controller 108 may use temperature information and humidity information to determine if “Cold and Rain” conditions still exist.

If the current weather condition 312 and/or time condition 314 have not changed, then the controller 108 may select 714 an antenna array direction weighting 316 from the antenna array direction weighting table 328. For example, the controller 108 may use the current weather condition 312 and time condition 314 to look up the corresponding antenna array direction weighting 316 in the antenna array direction weighting table 328. The controller 108 may then cause a motor 106 to rotate the antenna array 102 based on the selected antenna array direction weighting 316.

If the controller 108 determines 710 that the current weather condition 312 and/or time condition 314 have changed, then the controller 108 may determine 712 if the current weather condition 312 and time condition 314 are in the antenna array direction weighting table 328. In other words, the controller 108 may check whether the current environmental conditions match any previously recorded conditions. If the current weather condition 312 and time condition 314 are in the antenna array direction weighting table 328, then the controller 108 may select 714 the antenna array direction weighting 316 from the antenna array direction weighting table 328 corresponding to the current weather condition 312 and time condition 314.

If the controller 108 determines 712 that the current weather condition 312 and time condition 314 are not in the antenna array direction weighting table 328, then the controller 108 may cause 702 the motor 106 to rotate the antenna array 102 evenly to generate a new antenna array direction weighting 316 for the new weather condition 312 and time condition 314.

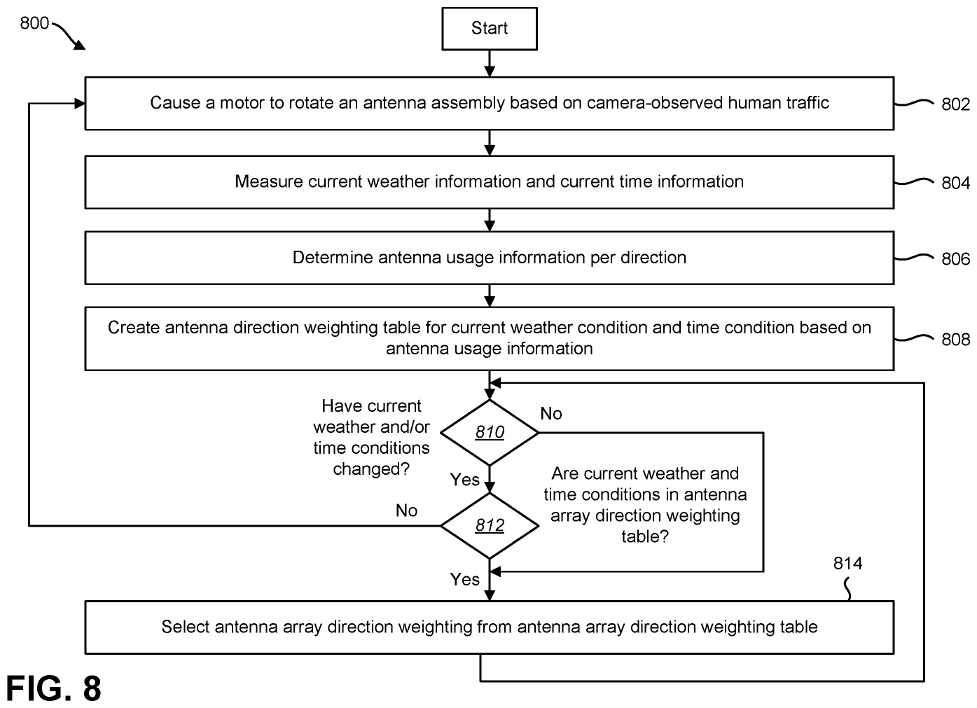

FIG. 8 is a flow diagram illustrating another example of a method 800 for antenna array direction weighting. The method 800 for antenna array direction weighting may be performed by, for example, the controller 108 described in FIG. 1 (and/or by the processor 308 described in FIG. 3).

The controller 108 may cause 802 a motor 106 to rotate an antenna array 102 based on camera-observed human traffic. For example, the controller 108 may receive camera information 336 (e.g., digital images or a video stream) from a camera 324. The controller 108 may detect human traffic in the camera information 336. The controller 108 may instruct the motor 106 to rotate the antenna array 102 to directions that have high human traffic.

The controller 108 may measure 804 current weather information and current time information. For instance, the controller 108 may receive weather information from a weather sensor 118 that is coupled to the antenna device 100. The weather sensor 118 may collect weather information at the antenna device 100. The weather information may include measurements of temperature, humidity (e.g., rain, snow, ice, dry, etc.), cloud-cover, barometric pressure, and/or wind. The controller 108 may obtain the time information from a clock (e.g., an on-board clock or network clock signal).

The controller 108 may determine 806 antenna usage information 334 per direction. For example, while the antenna array 102 rotates through a range of angles, the controller 108 may measure the number of client devices in communication with the antenna device 100 for different directions of the antenna array 102. In the context of 5G mmWave, the controller 108 may determine the 5G usage rate per direction. In some examples, the controller 108 may determine whether the camera-observed human traffic matches the measured antenna usage rate.

The controller 108 may analyze the collected data to create 808 an antenna array direction weighting table 328. For example, this may be accomplished as described in FIG. 7.

The controller 108 may determine 810 if current weather and/or time conditions have changed. For example, the controller 108 may analyze current weather information and time information to determine if previous weather and time conditions exist.

If the current weather condition 312 and/or time condition 314 have not changed, then the controller 108 may select 814 an antenna array direction weighting 316 from the antenna array direction weighting table 328. For example, the controller 108 may use the current weather condition 312 and time condition 314 to look up the corresponding antenna array direction weighting 316 in the antenna array direction weighting table 328. The controller 108 may then cause a motor 106 to rotate the antenna array 102 based on the selected antenna array direction weighting 316.

If the controller 108 determines 810 that the current weather condition 312 and/or time condition 314 have changed, then the controller 108 may determine 812 if the current weather condition 312 and time condition 314 are in the antenna array direction weighting table 328. If the current weather condition 312 and time condition 314 are in the antenna array direction weighting table 328, then the controller 108 may select 814 the antenna array direction weighting 316 from the antenna array direction weighting table 328 corresponding to the current weather condition 312 and time condition 314.

If the controller 108 determines 812 that the current weather condition 312 and time condition 314 are not in the antenna array direction weighting table 328, then the controller 108 may cause 802 the motor 106 to rotate the antenna array 102 based on camera-observed human traffic to generate a new antenna array direction weighting 316 for the new weather condition 312 and time condition 314.

1. An antenna device, comprising:
an antenna array coupled to a motor; and
a controller to (a) determine an antenna array direction weighting based on a weather condition and a time condition, and (b) cause the motor to rotate the antenna array based on the antenna array direction weighting.

2. The antenna device of claim 1, wherein the antenna array direction weighting comprises amounts of time that the antenna array faces different directions.

3. The antenna device of claim 2, wherein the antenna array direction weighting comprises time percentages for directions that the antenna array faces within a rotation cycle.

4. The antenna device of claim 1, wherein the controller is to determine the weather condition based on weather information collected by a sensor coupled to the antenna device.

5. The antenna device of claim 1, wherein the controller is to determine the antenna array direction weighting based further on camera information.

6. A non-transitory machine-readable storage medium comprising machine-readable instructions that when executed by a processor of an antenna device, cause the processor to:
determine current weather information and current time information;
select an antenna array direction weighting from an antenna array direction weighting table based on a weather condition and a time condition; and
cause a motor to rotate an antenna array of the antenna device based on the selected antenna array direction weighting.

7. The non-transitory machine-readable storage medium of claim 6, wherein the antenna array direction weighting comprises amounts of time that the antenna array faces different directions.

8. The non-transitory machine-readable storage medium of claim 6, wherein the antenna array direction weighting table comprises different antenna array direction weightings for different weather conditions and different time conditions.

9. The non-transitory machine-readable storage medium of claim 6, wherein the machine-readable instructions that cause the processor to select an antenna array direction weighting from an antenna array direction weighting table based on a weather condition and the time condition comprise machine-readable instructions that when executed by the processor, cause the processor to:
compare the current weather information and the current time information against weather conditions and time conditions in the antenna array direction weighting table.

10. The non-transitory machine-readable storage medium of claim 9, wherein the processor selects an antenna array direction weighting in the antenna array direction weighting table with a weather condition and a time condition that matches the current weather information and current time information.

11. An antenna device, comprising:
a weather sensor to generate current weather information;
a clock to generate current time information; and
a controller to:
create an antenna array direction weighting table for different weather conditions and different time conditions;
select an antenna array direction weighting from the antenna array direction weighting table based on the current weather information and the current time information; and
cause a motor to rotate an antenna array based on the selected antenna array direction weighting.

12. The antenna device of claim 11, wherein the antenna array direction weighting table comprises different antenna array direction weightings for the different weather conditions and the different time conditions.

13. The antenna device of claim 11, wherein the controller is to create the antenna array direction weighting table based on antenna usage information associated with the different weather conditions and the different time conditions.

14. The antenna device of claim 11, wherein the controller is to:
determine antenna usage information while the antenna array rotates through a range of directions;
measure a current weather condition and a current time condition; and
create an antenna array direction weighting for the current weather condition and the current time condition based on the antenna usage information.

15. The antenna device of claim 14, wherein the controller is to assign directions with high antenna usage a higher weighting in the antenna array direction weighting for the current weather condition and the current time condition than directions with low antenna usage.
